(19) United States
(12) Patent Application Publication
(10) Pub. No.: US 2008/0292771 A1
(43) Pub. Date: Nov. 27, 2008

(54) Meat and Stock Recovery Process and Products Thereof

(76) Inventors: Nicholas Anthony Jackman, Limerick (IE); John Francis Kerry, Laois (IE)

Correspondence Address: K&L Gates LLP, STATE STREET FINANCIAL CENTER, One Lincoln Street, BOSTON, MA, 02111-2950, US

(21) Appl. No.: 12/096,514

(22) PCT Filed: Dec. 6, 2006
(86) PCT No.: PCT/EP2006/069394

§ 371 Date: Jun. 6, 2008

(30) Foreign Application Priority Data
Dec. 8, 2005 (IE) 2005/0820
Aug. 28, 2006 (IE) 2006/0631

(51) Int. Cl. A23L 1/312; A23L 1/40; A23J 3/06

(52) U.S. Cl. 426/589

(57) ABSTRACT

The present invention is directed to the recovery of meat and stock from offal and the generation of enriched stock products derived from selected fractions arid products of this meat recovery process. Specifically the present invention relates to a meat recovery process comprising the general steps of collecting offal material, cooking the offal material in water, decanting the cooked material into a solids fraction and a liquor fraction, separating the solids fraction into meat material and bone material using a non-destructive gravity separation method and delivering said meat material and said bone material for further processing and reducing the water content of the liquor fraction to produce a concentrated stock product, Additionally, according to another aspect the present invention also discloses a process for making an enriched stock product comprising a collagen rich fraction.

This invention relates to the recovery of meat and stock from offal and the generation of enriched stock products derived from selected fractions and products of this meat recovery process.

The term offal, herein defined as under utilised meats, is usually defined as the hide, skin, feathers, intestine, soft tissue (liver, kidney, heart etc.) and blood (usually derived from primary slaughtering). However, under utilised meats (including meat-trim, fat, skin, tone, spent carcasses and other discards) usually generated in secondary processing may also fall under the general term offal. Animal by-product becomes inedible offal unfit for human consumption once it falls outside the chill chain and acceptable levels of hygienic handling, further processing and storage.

There are increasingly strict official regulations concerning the handling, rendering and disposal of meat offal. This has increased the handling costs for the safe disposal of this discard material.

The process of the invention deals with the selection of under-utilised meat materials (with and without bone inclusion) and the processing of this material.

Traditional meat stocks or “natural stocks” as used herein may be generated from all species, including bovine, ovine, avian and porcine meats. Meat stocks are traditionally generated by heating of meat based materials, including bones and spent or under utilised meat, in water. Typical ratios of water to meat are approximately 2:1 to 3:1. The resultant solution is heated to approximately 80° C. and allowed to simmer for a lime of 2 to 20 hours, wherein fat is removed during heating. The resultant stock is heated and cooled for a number of cycles to increase stock viscosity (body). The final stock is decanted and reduced via indirect heating. Further polishing may be employed (clarification) with the final product being subsequently packaged and chilled to, for example 4° C.

There are many disadvantages associated with traditional stock processes including the production of a significant amount of waste material and the associated need for disposal of this waste material.

It is an object of the present invention to provide an efficient stock and meat recovery process with a view to reducing the amount of this waste material and minimising disposal costs.

Another object of the present invention to provide a process for the production of enriched products derived from the products of this meat and stock recovery process.

According to a first aspect of the invention there is provided a meat recovery process for the generation of a natural stock or gelatine fraction comprising the steps of:
a. collecting offal material;
b. cooking the offal material in water;
c. decanting the cooked material into a solids fraction and a liquor fraction;
d. separating the solids fraction into meat material and bone material using a nondestructive gravity separation method, preferably a fluidised bed system, vibratory beds or sieve system, and delivering said meat material and said bone material for further processing; and
e. reducing the water content of the liquor fraction by evaporation or reverse osmosis to produce a concentrated stock product.

The liquor fraction obtained in step (c) is also known as the “mother liquor”.

This process provides several advantages over known processes.

One advantage of the process of the invention is the way in which the meat is separated from the bone after the stock has been decanted. Traditional methods for the separation of fresh meat from bone generally employ physical separation of meat from the bone using mechanical separation systems, for example techniques based on pressure, vacuum, shearing, sieve type systems and combinations thereof.

The present invention involves the non-destructive separating of bone from the meat when separating the solids fraction, preferably gravity separation techniques.

Preferably, the process includes separating the solids fraction by using fluidised bed technologies, vibratory beds and/or sieve systems which fractionate the meat on the basis of solids density and size. More preferably, the process of the invention uses a fluidised bed system. Such gravity separation techniques are not generally used in this type of process. These separation techniques allow for the non-destructive separation of bone material from meat.

Furthermore, these techniques allows for the separation of fine bone material that would not be removed using conventional sieving systems. The presence of bone has implications regarding food grade and safety issues. Thus, techniques which provide for the elimination of such fine bone material will be of great commercial importance.

Furthermore, the process of the invention has the additional advantage that the use of natural heating in water of the meat materials allows for the ready release of meal from the bone.

Another advantage is that the meat prepared from the above process has a fibre and texture unlike traditional mechanical meat recovery processes which disrupt meat fibre integrity and generate meat fractions which resemble an undesirable amorphous paste. The recovered meat has a fibre and texture similar to regular meat.

Yet another advantage is that this process allows for the de-pigmentation of dark meals which are high in myoglobin. The use of water and heat denatures the myoglobin. Thus, the meat separated according to the invention is pale in colour and allows for the generation of white meats from dark meal without the need for the use of chemicals, such as hydrogen peroxide.

Essentially, this process provides for the effective separation of meat from bone while maintaining the meat integrity and fibrous nature of the meat.

The meat may then be utilised as a meat ingredient for value added processing as is or incorporated with fresh meat and subject to further processing such as chopping/mincing, cooking/roasting or addition of flavouring/seasoning and subsequent filling into containers as a cooked restructured meat log or loaf. The containers may then be sterilised/pasteurised and chilled until dispatch. Other further processing steps may be involved.

This procedure allows for bones and non-recovered meat and fats to be delivered for further processing in, for example, pet food manufacture.

In another embodiment of the invention, the stock manufacturing process may comprise the further steps of other natural ingredient additions, such as vegetables, natural herbs, spices etc, to the offal/underutilised-meal material prior to or during cooking in water.

In another embodiment of the invention, the process may comprise the steps of reheating and cooling the mother liquor over a number of cycles to enhance the viscosity and body of the stock.

Another advantage of the process is that the concentrated stock obtained from the process may be controlled from a colour and visual appearance aspect. The controlled high heal treatment of the stock product during the process reduces the associated Maillard browning and allows greater control of the final product colour.

Furthermore, the process of the present invention provides high product throughput where there is less waste and hence, associated labour and energy savings.

In yet another embodiment of the invention the process includes reducing the water content of the liquor fraction by plate evaporation or by reverse osmosis. Traditional systems use standard boiling systems or shallow pan systems. The use of evaporation techniques according to the invention, such as plate evaporation, to dewater the stock provides a significant improvement in terms of speed, capacity and quality control.

Furthermore, the present invention allows the manipulation of the total solids present in the stock, by stock reduction to achieve levels ranging from approximately 10%-80%, preferably 20% to 30% by weight based on the total stock. This is important as stock quality is graded on the basis of total solids and colour while maintaining an acceptable flavour profile. This is a significant advantage.

In another embodiment the process includes further reducing the concentrated stock by flash healing. This will typically involve the evaporation of the liquor using aggressive heating and a large surface area provided in shallow heating pans. This allows stock colour and flavour to be controlled by flash, heating post dewatering (evaporation) and allows control of the Maillard reaction that occurs to achieve a desired flavour and colour.

The Maillard reaction is a chemical reaction between an amino acid and a reducing sugar, usually requiring the addition of heat. The reactive carbonyl group of the sugar interacts with the nucleophilic amino group of the amino acid and poorly characterized odour and flavour molecules result. The reaction is the basis of the flavouring industry, since the type of amino acid determines the resulting flavour.

In the process, hundreds of different flavour components are created. These compounds in turn break down to form yet more new flavour compounds and so on. Each type of food has a very distinctive set of flavour compounds that are formed during the Maillard reaction. It is these same compounds that flavour scientists have been using over the years to create artificial flavours.

In a further embodiment the process includes reducing the (mother) liquor fraction to a solids content in the order of 25-35% total solids, preferably in the order of 28-32% total solids, and most preferably about 30% total solids.

In another embodiment the process includes further drying the concentrated stock for increasing the solids content to about 60-80% total solids. This further drying may conveniently be carried out by spray drying or roller drying. If desired a paste (10 to 15% water content.) or anhydrous powder product (with less than 6% water content) may be produced.

In another embodiment the process includes cooking the offal material in water. Preferably the ratio of offal to water is in the range 1:1 to 1:5. Typically the cooking is carried out at a temperature in the range 60-100° C. for a period in the range 2 to 20 hours.

Further fractions generated during the production of this stock liquor and solids meat/bone fraction include a water-based liquid with 5 to 10% total solids (which farms the initial stock mother liquor), an oil fraction and a gelatine or refined gelatine fraction. These oil and gelatine fractions may be further processed and used in further processing and/or in components of the Nu Stoc™ or Nutri Stoc™ range of ingredients.

In another embodiment the process includes removing fat, gelatine and light solids which migrate to the surface/upper strata of the stock liquor during heating. This removal may conveniently be carried out using air or any other suitable removal method. Preferably, fat separation further involves the recovery of free fat for further processing. Fat is decanted and clarified using forced gravity separation which removes fines and generates very pure grade oil. This pure grade oil may be used as an ingredient in food processing.

According to another embodiment of this aspect of the invention, the meat recovery process defined above further comprises the steps of
f. collecting a collagen rich source;
g. preparing a collagen rich fraction from collagen rich underutilised meat sources;
h. blending the collagen rich fraction with the concentrated stock product obtained from the process as defined above; and
i. preparing a micro-emulsion formulation of concentrated stock product and collagen rich fraction to form an enriched stock product.

This aspect of the invention is further defined in more detail below.

Optionally, functional food ingredients may be added to the collagen rich fraction either before or after combination with the natural or concentrated stock, Again this aspect of the invention is further defined in more detail below.

A second aspect of this present invention deals with the preparation of an enriched stock product for use in the further processing of meats, processed meats or meat based products (Nu Stoc™ or Nutri Stoc™).

The advent of strict legislation within the EU and other jurisdictions pertaining to the type of added ingredients that may be added to meat products and the reform of labelling requirements has resulted in the sourcing of ingredients that are functional (in terms of water and fat binding), safe (traceability issues) wholesome and non-allergenic. This aspect of the present invention, addresses these issues.

The term “enriched stock product” used herein will be understood to cover any natural meat stock derived from specific species (such as avian, bovine or porcine) containing a collagen-rich fraction also obtained during the production of natural stock. It will also be understood to encompass a gelatine fraction derived from the meat stock process containing a collagen-rich fraction.

According to this aspect of the present invention, meat stock may be generated in the traditional manner or according to the process described above with the natural stock or concentrated stock according to the invention or gelatine fraction being manipulated through the direct addition of collagen rich fractions.

According to one aspect of the invention, there is provided a process for preparing an enriched stock product comprising the steps of:
a. collecting a collagen rich source:
b. preparing a collagen rich fraction from the collagen rich source;
a blending the collagen rich fraction with a natural stock; and
d, preparing a micro-emulsion formulation to form an enriched stock product.

A more specific embodiment of this aspect of the present invention, comprises a process for preparing an enriched stock product comprising the steps of
a. collecting a collagen rich source;
b. preparing a collagen rich fraction from the collagen rich source;
c. blending the collagen rich fraction with natural stock, preferably the concentrated stock produced in accordance with the present invention, or with the gelatine fraction obtained during the process of the present invention; and
d. preparing a micro-emulsion formulation of concentrated stock product or natural stock or gelatine fraction and the collagen rich fraction to form an enriched stock product.

Preferably, the collagen enriched fraction is sourced from collagen rich under-utilised meat derived sources. These sources include pork rind, chicken skin, beef cerium layer or any meat cut high in connective tissue, for example, forequarter cuts.

According to one embodiment of this aspect of the invention, the collagen rich sources are processed through the general steps of traditional stock process production including heat treatment in combination with controlled physical shearing techniques. The use of physical shearing techniques on collagen fibre results in a particle size reduction and a resultant increase in protein surface area. The application of controlled shearing, to less than 1 micron to 1 mm particle size, in conjunction with controlled heating techniques (60° C. to 100° C. for 2 to 8 hours) generates similar unfolding and protein solubilization to that achieved by chemically induced solubilisation techniques.

Application of physical reduction of protein particle size versus chemical solubilisation is clearly a more desirable process as it removes the need for chemical/additive interventions and maintains a natural process for high concentrate gelatine stock manufacture. Physically modified protein versus chemical modification affords a clean ingredient declaration whilst allowing the effective manipulation of collagen protein structure in combination with controlled heating cycles in the presence or absence of pH adjustment (i.e. employing organic acids) of the gelatine rich fraction. This results in the controlled development of gelatine products as enrichment fractions for use in general stock preparation according to the present invention.

Reducing the particle size, increases the surface area and essentially changes the physicochemical properties of treated solution, i.e. altering its viscosity and water binding capacity of the stock product. This is advantageous as the treated solution can become a water binding adjunct. Furthermore, the protein is modified in a controlled fashion wherein the total solids are increased without having to use excessive heat treatment to dewater.

Ideally, shearing the solids involve grinding and particle size reduction of collagen rich fraction to a defined particle size. Preferably, the particle size is up to a maximum of 1 mm. Ideally, the particle size is from less than 1 micron to 1 mm. Any conventional shearing apparatus may be used, although it must be able to achieve the desired particle size reduction range and be able to complete the shearing in the presence of heat. Apparatus such as agitated media milts which can grind particle down to lower than 10 nm may be used. Resultant particles may have to be sterilised against re-agglomeration by the use of chemical additives or an electrostatic or steric mechanism. Alternatively, high pressure valve homogenisers or microfluidizers may be utilised.

Mild pH adjustment using organic acids may also be employed at this step to enhance collagen solubilisation. Optionally, pasteurisation/sterilization may also occur at this stage. Additionally, the process may involve the removal of fat and other solids, and physically shearing the remaining solids to generating an amorphous paste. The heating step and shearing accelerates the solubilisation of the collagen to gelatine or semi-refined collagen.

According to another embodiment of the invention step the collagen rich fraction is produced from the collagen rich source by the steps of heat treatment, following by separating the fat and solids and subsequently shearing the solids from the collagen rich source to form a collagen rich fraction of defined particle size.

Preferably, heal treatment takes place from approximately 80 to 120° C. for approximately 120 to 240 minutes and the heating and cooling cycle can be repeated in order to manipulate the collagen source and modify stock viscosity and overall body/consistency.

Preferably, fat separation further involves the recovery of free fat for further processing. Fat is decanted and clarified using forced gravity separation which removes fines and generates very pure grade oil. This pure grade oil may be used as an ingredient in food processing.

Ideally, the ratio of stock to collagen rich fraction is based on the concentration of proline in the fractions. The total solids also dictate the final ratios in terms of mixing.

Preferably the ratio of collagen rich fraction to natural or concentrated stock is from approximately 1:1 to 1:4. These form the resultant micro-emulsion formulation.

As discussed above the resultant micro-emulsion formulation contains the sheared collagen rich fraction of defined particle size and the natural stock. The vast majority of particles within the micro-emulsion will be of defined size (from less than 1 micron to 1 mm) and as expanded on above, these particles distribute readily within the formulation i.e. natural stock to provide a resultant “micro-emulsion” formulation. It is the collagen rich fraction which acts as a carrier for the functional food ingredient defined below.

The micro-emulsion formulation may optionally be subjected to a further heating, blending and/or shearing step.

It is this micro-emulsion formulation which can be used as an enrichment fraction for general stock preparation.

Ideally, the concentrated stock has a solid content from approximately 50 to 80% total solids.

Optionally, the process according to both aspects of the invention may further comprise the steps of packaging and chilling the resultant formulation.

The collagen enrichment of the natural stock or concentrated stock according to the invention results in an increased amount of total solids and improved functionality in terms of water fat binding and film formation. Total solids increase the water binding capacity and protein content. The collagen rich fraction can act as an emulsifier, however, its main advantage is that of water binding within meat systems.

The concentrated stock fraction and enriched stock fraction of the invention can be injected into whole muscle meals (reformed meats) and meat products (restructure and comminuted meats) and these products have the physical and chemical ability to bind water in meats.

This enriched stock product based on the refined gelatine fraction can also be used as a coating, glaze or edible film.

According to another aspect of this invention functional food ingredients may be added to the collagen rich fraction either before or after combination with the natural or concentrated stock or gelatine fraction. Additionally, the gelatine fraction may also comprise a functional food ingredient. In this way the gelatine fraction acts a carrier for the functional food ingredient (Nutri Stoc™).

According to this embodiment of the invention, the functional food ingredient may be directly added to the to the micro-emulsion formulation or to the collagen rich fraction prior to blend with the stock or gelatine product. Thus, the functional food ingredient is added post healing/pasteurisation of the meat or related food product.

Functional foods according to the invention will be understood to be foods or food ingredients which are enriched with additional health/nutritional benefits. These foods may also be known as “nutraceutcials” which are food or parts of food which provide medicinal or health benefits including the prevention or treatment of disease. They may be selected from a naturally nutrient-rich or medicinally active food, such as garlic or soybeans, or it may be a specific component of a food, such as the omega-3 fish oils derived from salmon or other cold water fish.

In this way these functional foods may be applied to meat, processed meat or meat-based products using natural stock as the carrier pre- or post-cooking as explained above.

The addition of such functional foods provides a significant value added effect to the stock or gelatine fraction.

Preferably, functional foods include natural preservatives such as nisin, phytoslerols and antioxidants, omega 3 fatty acids, vitamins and minerals.

Nisin is an inhibitory polycyclic peptide with 34 amino acid residues and is commonly used as a food preservative. It contains the uncommon amino acids lanthionine, methyllanthtonine, dehydroalanine and dihydro-amino-butyric acid. These special amino acids are synthesized by posttranslational modifications. Nisin is produced by fermentation using the bacterium Lactococcus lactis. Commercially it is obtained from natural substrates including milk and is not chemically synthesized. It is used in processed cheese production to extend shelf life by suppressing gram-positive spoilage and pathogenic bacteria. There are many other applications of this preservative in food and beverage production. Due to its highly selective spectrum of activity it is also employed as a selective agent in microbiological media for the isolation of gram-negative bacteria, yeast and moulds. Subtilin and Epidermin are related to Nisin. As a food additive, nisin has E number E234.

An antioxidant is a chemical that reduces the rate of particular oxidation reactions in a specific context, where oxidation reactions are chemical reactions that involve the transfer of electrons from a substance to an oxidising agent.

Phytosterols (also called plant sterols) are a group of steroid alcohol, phytochemicals naturally occurring in plants. They are white powders with mild, characteristic odor, insoluble in water and soluble in alcohols. They have many applications as food additives, and in medicine and cosmetics. Plants contain a range of phytosterols.

They act as a structural component in the cell membrane, a role which in mammalian cells is played by cholesterol. As a food additive, phytosterols have cholesterol-lowering properties (reducing cholesterol absorption in intestines), and may act in cancer prevention. Phytosterols naturally occur in small amounts in vegetable oils, especially soybean oil. One such phytosterol complex, isolated from vegetable oil, is cholestatin, composed of compesterol, stigmasterol, and brassicasterol and is marketed as a dietary supplement. The mechanism behind phytosterols and the lowering of cholesterol occurs as follows: the incorporation of cholesterol into micelles in the gastrointestinal tract is inhibited, decreasing the overall amount of cholesterol absorbed. This may in turn help to control body total cholesterol levels, as well as modify HDL, LDL and TAG levels. Many margarines, butters, breakfast cereals and spreads are now enriched with phytosterols and marketed towards people with high cholesterol and a wish to lower it.

According to another aspect of the invention, there is provided the use of a concentrated stock product or enriched stock product according to the invention in the production of a meat, processed meats or meat based product.

According to one embodiment of this aspect of the invention, the enriched stock product is directly added or injected to a meat, processed meat or meat based product. It will be understood that processed meats include reformed, restructured and comminuted meats.

Furthermore, another major advantage of the present invention is that the direct addition of these enriched stocks to meat products reduces the need for the addition of chemical aids, such as phosphates, and other meat binders, such as polysaccharides including starch and carrageen and proteins such as soya, dairy, wheat and combination blends.

According to yet another embodiment of this aspect of the invention, the collagen enriched stock product may be used as a phosphate replacer. The enriched stock product is a protein product that can bind water, thus, it can replace phosphate salts as a chemical which as a water binder by changing the pH and structure of meat. This stock is a natural alternative to known water binders. Furthermore, other protein binders used in conventional meat processing include dairy proteins and soya both of which have allergen issues associated with them. The enriched stock of the present invention is allergen free, natural, and tailor made to be meat species specific.

According to another aspect of the invention, the gelatine fraction obtained during the separation of the solids from the stock liquor or enriched stock product containing the gelatine fraction may be used as a coating, glaze or edible film for meats or meal based products, (Nutri Stoc™).

Specifically, the gelatine fraction may be employed as a barrier film post cooking.

For this application the gelatine fraction may be sprayed onto the surface of various meat products as a pre pasteurised/sterilised fine bio or edible film to generate a natural oxygen impermeable coating system on the surface of such meat products on setting post cooling. This enhances the colour and stability of the product where surface colour fading as a function of time due to continuous freezing or chilling is a problem. Colour fading is realised in blast chilled/frozen products where surface oxidation through exposure to forced chilled air Colour fading may also be an issue especially in the case of skin on products such as chicken, beef and pork products.

It will be understood that the enriched stock and gelatine product according to the invention are a meat based natural, wholesome, safe (pasteurised or sterilized) meat extender which can be generated for use with each meat type. The enriched products of the invention provide the advantage that they are meal based and can be defined as a natural meat based ingredient in compliance with food regulation requirements.

Furthermore, the enriched functional food stock product may be used as a phosphate replacement ingredient, fortified stock, sauce, gravy and edible film/glazing Ingredient for using post coating for use in meats, processed meats or meat-based products. The enriched stock product with functional food may be used in the same way as the enriched stock product but will have different health benefits according to the functional food used.

The invention will be more clearly understood by the following description of some embodiments thereof, given by way of example only, with reference to the accompanying drawings, in which:

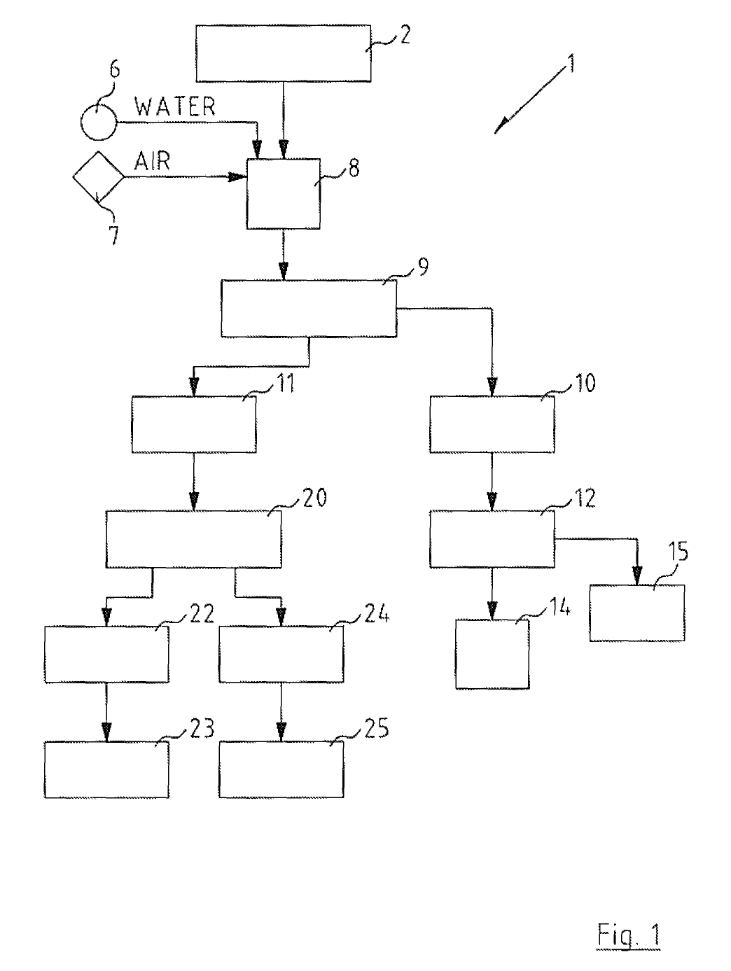

FIG. 1 is a schematic How chart illustrating a meat recovery process according to the invention;

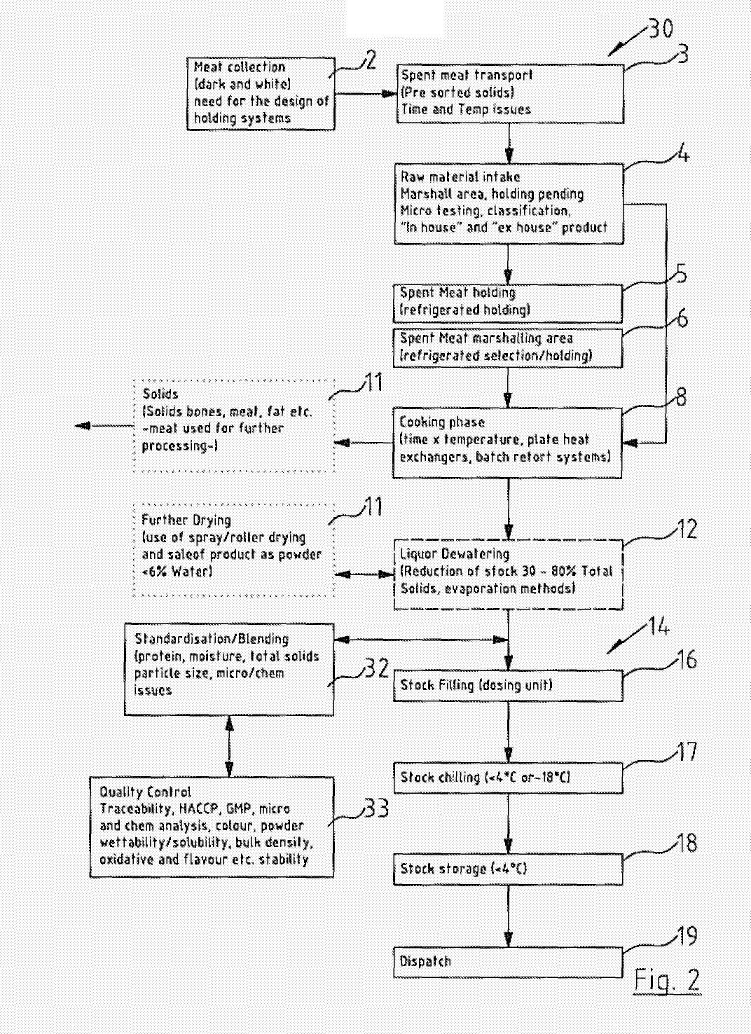

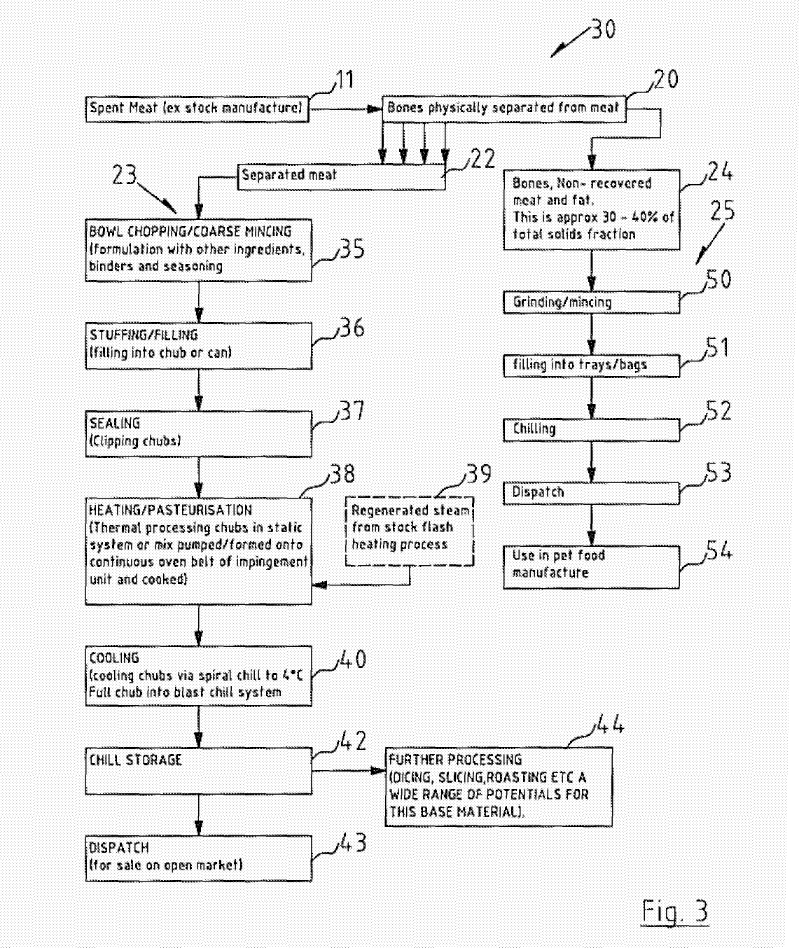

FIGS. 2 and 3 are schematic flow charts illustrating another meat recovery process of the invention;

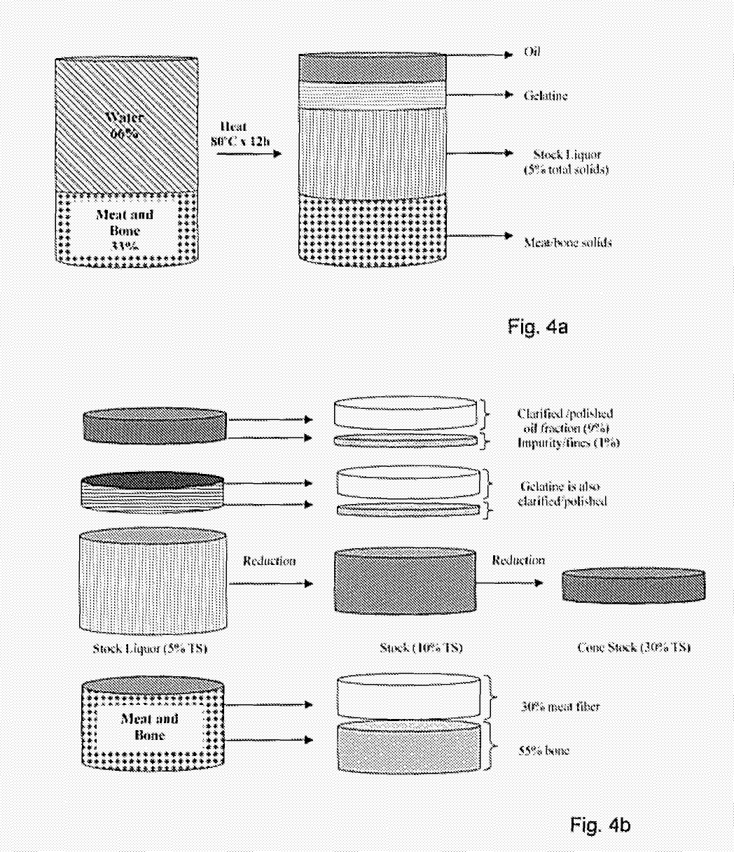

FIG. 4 shows the different fractions obtained during stock production; and

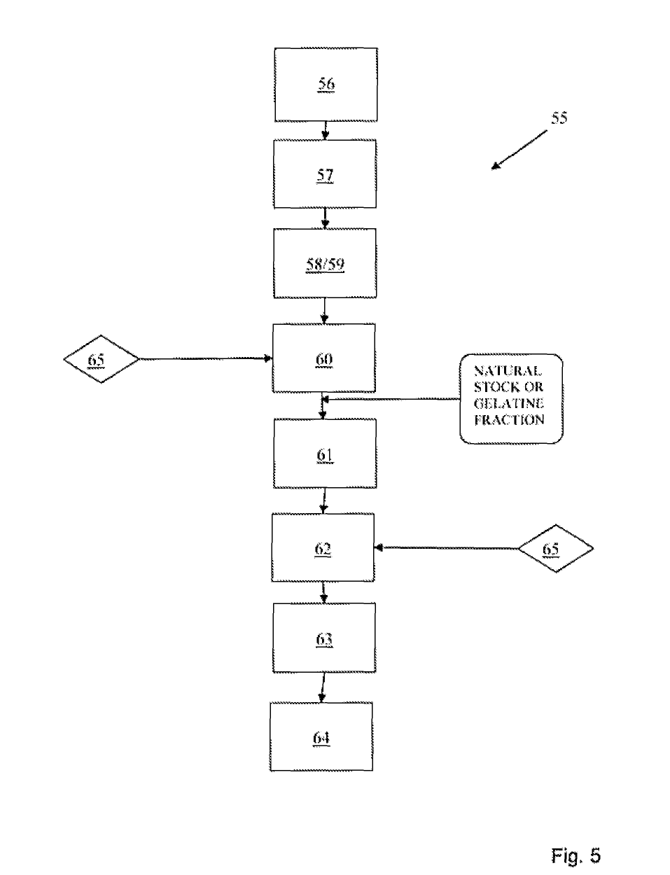

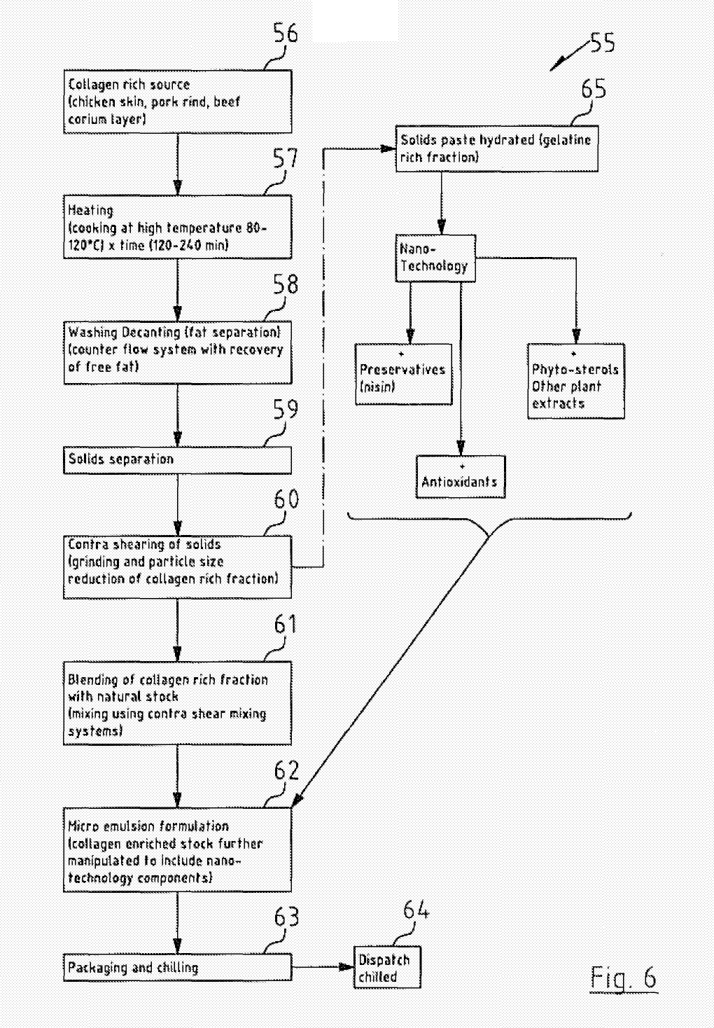

FIGS. 5 and 6 are schematic flow charts illustrating the process for forming an enriched stock product according to the invention.

Referring to the drawings, and initially to FIG. 1 thereof, there is illustrated a meat recovery process according to the invention indicated generally by the reference numeral 1. Offal material 2 is collected. This may be waste materials generated for example during primary or secondary processing. A quantity of offal material is delivered with water in the ratio 1:1 to 1:5 respectively to a cooking station 8, Water is delivered from a water supply source 6 to the cooking station 8. The offal material is heated in the water within a temperature range of 60-100° C. for 2-10 hours. Fat and light solids that migrate to the surface of the liquid are physically removed using air, from a pressurised air supply source 7 for example, or one of a range of other separation methodologies The heating of the material will result in the generation of a stock liquor and a solids fraction. It will also result in the generation of an oil and gelatine fraction, as described in FIGS. 4a and 4b below.

The cooked material is decanted 9 to separate the cooked mixture into a liquor fraction 10 and a solids fraction 11.

The wafer content of the liquor fraction 10 (containing a total solids content of about 3-7%) is reduced at a dewatering station 12 by plate evaporation or by reverse osmosis. This provides rapid dewatering of the liquor with a relatively low energy consumption. If desired reduced stock may be finished through flash healing, (in shallow heating pans) in order to generate a desirable colour and flavour in the final stock. The dewatering concentrates the stock liquor to achieve a solids content of about 30% total solids. The concentrated stock product thus produced may be delivered for further processing 14. Some or all of the concentrated stock product may be delivered for further drying 15 by spray or roller drying for example to prepare a stock paste in which the total solids of the stock concentrate are increased to about 60-80% total solids. A powder product having a water content of less than 6% may be produced.

The solids generated in the stock preparation are essentially pasteurised due to the high temperature and time employed during the cooking phase at the cooking station 8. The application of heat results in the meat falling from the bone material as the collagen and connective tissue are solublised and converted to gelatine. While the meat is pasteurised and is in a fibrous form (possesses its meat texture and quality), the bone fraction and heavy cartilage has to be extracted in order to realise the value of the meat.

The solids fraction 11 is separated 20 into meat material and bone material using fluidised bed technologies, vibratory beds and sieve systems to fractionate the meat on the basis of solids density and size. This non-destructive separation of bone from meat results in a meat stream 22 that is acceptable for further processing 23 to produce food products for example. There is effective separation of meat from bone white maintaining meat integrity. The fibrous nature of the meat is retained.

Bones 24 together with non-recovered meat and fat (this will be approximately 30-40% of the total solids fraction) is delivered for further processing 25 for example to produce a product for use in pet food manufacture.

Referring now to FIGS. 2 and 3 there is illustrated another meat recovery process indicated generally by the reference numeral 30. Steps in the process 30 similar to those in the process described previously are assigned the same reference numerals. The offal material 2 may be collected from a number of sources either on-site or from one or more remote sites. The offal material is transported 3 to the processing area having a raw material intake 4. At the intake 4 various testing and classification may be carried out as required. If not being used immediately the offal material may be retained in a refrigerated holding station 5. When required the offal may be prepared in a marshalling area 6 prior to delivery to the cooking station 8 together with water for cooking as previously described.

After cooking the material is decanted with the liquor fraction being delivered, to the dewatering station 12 and the solids fraction 11 being separated 20 in to the meat stream 22 and bone stream 24.

After dewatering 12 as previously described further stock processing 14 may include stock filling 16 of containers followed by chilling 17 to below 4° C. or if required freezing to −18° C. The stock is then delivered into storage 18 ready for dispatch 19 as required.

Standardisation or blending 32 and quality control 33 steps may be carried out as required.

As described before the solid fraction 11 is separated 20 into meat 22 and bone 24 material. The further processing 23 of the meat stream 22 may include for example bowl chopping or coarse mincing 35. Additional ingredient materials such as binders and seasonings may be added to the meat as required. At a filling station 36 the meat mixture may be stuffed or filled into chubs or cans which are delivered to a sealing station 37 for closure of the container. Containers are then delivered to a heating/pasteurisation station 36 for cooking and/or pasteurisation of the product, Regenerated steam 39 from the stock flash healing process may be used in the heating or pasteurisation 38 of the product.

The product is then cooled 40 and delivered to chill storage 42 awaiting dispatch 43. Alternatively further processing 44 may be carried out prior to dispatch, said further processing including dicing, slicing or roasting for example.

The bone material 24 will include non-recovered meat and fat. This bone material may be delivered for further processing 2S which includes grinding/mincing 50. The bone material is then filled 51 into trays, bags or other containers. The containers are delivered for chilling 52 prior to dispatch 53 for use in pet food manufacture 54 for example.

It will be noted that the dewatering of the stock material and the physical segregation of bone material from meat may be carried out in a dedicated separation chamber or room.

It will be appreciated that the invention provides an improved process for the efficient dewatering of stock material which facilitates the rapid handling of stock material with improved throughput or capacity.

Further, effective separation of meat from bone is achieved whilst maintaining meat structural integrity and retaining the fibrous nature of the meat due to the non-destructive gravity separation process employed. There is also maintenance of the safety (microbial) and wholesomeness of the meat during this phase.

The invention provides a process for the effective segregation of expensive under-utilised meal material for further food processing.

FIGS. 4a and 4b show the fractionation and reduction stages of stock production. After initial heating, a stock liquor with approximately 5% total solids (FIG. 4a) is generated that can be further reduced to generate a 30% total solids stock (FIG. 4b). Additional fractions are also generated including an oil fraction which can be clarified and polished to give edible oil approx. 9% of total volume. A pure gelatine fraction can also be generated. These edible oil fractions and pure gelatine fractions, which are also classified as stock products, can be used in the further processing of the meat and stock products.

Referring now to FIGS. 5 and 6 there is illustrated a process for the preparation of an enriched stock product according to the invention indicated generally by the reference numeral 55.

Referring to FIG. 5, there is illustrated a process for the preparation of an enriched stock product according to the invention indicated generally by the reference numeral 55. The collagen rich source 56 is collected. The collagen rich source is then heated at a cooking station 57 within a temperature range of 80-120° C. for 2-20 hours. Fat 58 and light solids 59 that migrate to the surface of the liquid are physically removed using conventional separation methodologies. The remaining mixture is then sheared to a defined particle size (generally from less than 1 micron to 1 mm) to form a collagen rich fraction 60.

The collagen rich fraction is then blended 61 with a natural stock or concentrated stock produced in accordance with the process of the invention, to form a micro emulsion 62 which is the enriched stock product of the invention. Alternatively, the collagen rich fraction is blended with the gelatine fraction obtained during the production of the concentrated stock product. If desired, the micro-emulsion may be subjected to a further heat treatment, blending and/or shearing step.

This is then packaged, chilled 63 and is then ready for dispatch 64.

A functional food 65 ingredient may be introduced at step 60 or step 62, i.e. before or after blending the collagen rich fraction with the natural stock, concentrated stock or gelatine fraction but post healing. The collagen rich fraction acts as a carrier for the functional food ingredient.

According a more specific embodiment of this invention illustrated in FIG. 6, a collagen rich source, from for example chicken skin, pork rind and beef corium layer 56 is collected. This is then processed according to 57 to 60 to form a collagen rich fraction of desired properties. These properties include that it has an ability to form a thermoreversible gel, if is water soluble, colourless, odourless with a good flavour profile, safe and wholesome.

Essentially, the collagen rich source is heated (57), the fat is removed (58), the solids are separated (59) and the resultant product is sheared to form the collagen rich fraction.

The collagen rich fraction may then be blended with natural stock (61) or stock, produced in accordance with the process of the invention to form a micro-emulsion (62) which is the enriched stock product. It may be subjected to further heat/blending or mixing steps, ft may then be packaged and chilled (63) and then dispatched (64). Alternatively, it may be blended with the gelatine fraction obtained during the production of the concentrated stock product.

Alternatively, a functional food ingredient (65) may be added to the collagen rich fraction (60) prior to blending with natural stock or the gelatine fraction.

Another alternative includes adding the functional food ingredient (65) to the micro emulsion formulation at step 62. i.e., after the collagen rich fraction has been blended with the natural stock or gelatine.

Optionally, the gelatine fraction (see FIGS. 4a and 4b) may be combined with the functional food ingredient. The gelatine fraction acts as a carrier. The gelatine/functional food ingredient are then combined with the collagen rich fraction as defined previously.

The invention is not limited to the embodiments hereinbefore described which may be varied in both construction and detail.

1. A meat recovery process comprising the steps of
a. collecting offal material;
b. cooking the offal material in water at a temperature of from 60 to 100° C. for approximately 2 to 20 hours and wherein the ratio of offal to water is in the range of approximately 1:1 to 1:5;
c. decanting the cooked material into a solids fraction and a liquor fraction;
d. separating the solids fraction into meat material and bone material using a non-destructive gravity separation method, preferably a fluidised bed system, vibratory beds and/or sieve system, and delivering said meat material and said bone material for further processing; and
e. reducing the water content of the liquor fraction by plate evaporation to produce a concentrated stock product, removing fat, oil gelatine and light solids which migrate to the surface of the liquor fraction when cooking, and separating out the oil fraction and/or the gelatine fraction from the liquor fraction for further processing.

2. (canceled)

3. The process according to claim 1 wherein the concentrated stock product is further reduced by flash heating.

4. The process according to claim 1 including reducing the liquor fraction to have a solids content of approximately 25 to 35% total solids, preferably approximately 28 to 32% total solids, more preferably approximately 30% total solids.

5. The process according to claim 1 further comprising the step of further drying, preferably by spray drying or roller drying, the concentrated stock to increase the solids content to approximately 60 to 80% total solids.

6-8. (canceled)

9. The meat recovery process according to claim 1 further comprising the steps of:
f. collecting a collagen rich source;
g. preparing a collagen rich fraction from the collagen rich source;
h. blending the collagen rich fraction with the concentrated stock product or the gelatine fraction from step (e); and
i. preparing a micro-emulsion formulation of concentrated stock product or gelatine fraction and collagen rich fraction to form an enriched stock product.

10. The process according to claim 9 further comprising the step of adding a functional food ingredient to one or more of the following, the collagen rich fraction, the gelatine fraction, the concentrated stock fraction and/or to the enriched stock product.

11. The process according to claim 10 wherein the functional food ingredient is selected from one or more of the following natural preservatives such as nisin, phytosterols, antioxidants, omega 3 fatty acids, vitamins and/or minerals.

12. The process according to claim 9 wherein step (g) comprises traditional stock manufacture processing methods.

13. The process according to claim 12 comprising the steps of heat treating the collagen rich source, separating the fat and solids and subsequently shearing the solids from the collagen rich source to form a collagen rich fraction.

14. The process according to claim 13 wherein heat treatment takes place from approximately 80 to 120° C. for approximately 120 to 320 minutes.

15. The process according to claim 9 wherein the collagen rich fraction and the concentrated stock product are mixed in a ratio of from approximately 1:1 to 1:4.

16. The process according to claim 1 further comprising the steps of packaging and chilling the concentrated stock product or enriched stock product.

17. The process according to claim 1 wherein the collagen rich source is selected from one or more of the following chicken skin, pork rind and/or beef corium layer.

18. The process according to claim 1 comprising the further step of directly adding or injecting the concentrated stock product or enriched stock product to a meat, processed meat or meat based product.

19. The process according to claim 9 comprising the further step of spraying the gelatine fraction or enriched stock product onto the surface of meat, processed meat or meat based products to form a coating, glaze or film on the surface of the meat, processed meat or meat based products

20. Use of the concentrated stock product or enriched stock product produced according to claim 1 in the production of meat, processed meats or meat based product; or as a phosphate replacer.

21. Use of the gelatine fraction produced according to claim 1 as a coating, glaze or edible film for a meat, processed meat or meat based product.

22. A meat, processed meat or meat based product comprising the concentrated stock product produced according to claim 1.

23-34. (canceled)

35. The process according to claim 13 wherein the shearing step achieves a particle size less than 1 micron to 1 mm.

36. Use of the enriched stock product-produced according to claim 9 in the production of meat, processed meats or meat based product; or as a phosphate replacer.

37. Use of the enriched stock product produced according to claim 9 as a coating, glaze or edible film for a meat, processed meat or meat based product.

38. A meat, processed meat or meat based product comprising the enriched stock product produced according to claim 9.
